(19) United States
(12) Patent Application Publication
(10) Pub. No.: US 2007/0263129 A1
(43) Pub. Date: Nov. 15, 2007

(54) DISPLAY DEVICE AND MANUFACTURING METHOD THEREOF

(75) Inventors: Won Sang Park, Yongin-si (KR); Jin Hyuk Yun, Seoul (KR); Chi Woo Kim, Seoul (KR); Seok Won Park, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/746,085

(22) Filed: May 9, 2007

(30) Foreign Application Priority Data
May 11, 2006 (KR) 1020060042214

(51) Int. Cl. G02F 1/1335

(52) U.S. Cl. 349/12

(57) ABSTRACT

A display device includes a liquid crystal panel including an upper substrate and a lower substrate facing each other with liquid crystals being disposed therebetween, a first polarizing plate bonded to a front surface of the liquid crystal panel and a touch panel including a lower electrode formed on the upper substrate of the liquid crystal panel and an upper electrode formed on a back surface of the first polarizing plate. The liquid crystal panel further includes a thin film transistor formed on the lower substrate, a pixel electrode connected to the thin film transistor, a color filter formed on the lower substrate and a common electrode formed on the upper substrate and forming an electric field with the pixel electrode.

This application claims priority to Korean Patent application No. 2006-0042214, filed May 11, 2006, and all the benefits accruing therefrom under 35 U.S.C. §119, the contents of which in its entirety are herein incorporated by reference.

### BACKGROUND OF THE INVENTION

1. Field of the Invention

The present invention relates to a display device, and more particularly, to a display device capable of making it thin and lightweight, and a manufacturing method thereof.

2. Description of the Related Art

There are various kinds of display devices for displaying images, such as a cathode ray tube, a liquid crystal display, a plasma display panel, an electro-luminescence display, etc. In order to easily input information on a screen, many display devices use a touch panel installed on the surface of the screen as an input device. If a user presses the surface of the screen with a pen or finger, information corresponding to the pressed location is input.

However, since such a display device increases in thickness by the thickness occupied by the touch panel, it is difficult to achieve a thin and lightweight device. Especially, the touch panel increases in thickness by upper and lower films on which its electrodes are formed.

### BRIEF SUMMARY OF THE INVENTION

An exemplary embodiment provides a display device being relatively thin and lightweight, and a manufacturing method thereof.

In an exemplary embodiment a display device includes a liquid crystal panel including an upper substrate and a lower substrate facing each other with liquid crystals being disposed therebetween, a first polarizing plate bonded to a front surface of the liquid crystal panel and a touch panel including a lower electrode formed on the upper substrate of the liquid crystal panel and an upper electrode formed on a back surface of the first polarizing plate. The liquid crystal panel includes a thin film transistor formed on the lower substrate, a pixel electrode connected to the thin film transistor, a color filter formed on the lower substrate, and a common electrode formed on the upper substrate and forming an electric field with the pixel electrode.

In an exemplary embodiment, the touch panel further includes first and second signal supply lines formed on edges of the upper electrode, third and fourth signal supply lines formed on edges of the lower electrode, an insulation adhesive formed between the first and second signal supply lines and the third and fourth signal supply lines, and a touch spacer formed on the upper electrode.

In an exemplary embodiment, the touch panel further includes a first cell gap maintainer formed of the same material on a same plane as the first and second signal supply lines and a second cell gap maintainer formed of the same material on a same plane as the third and fourth signal supply lines.

In an exemplary embodiment, the display device further includes a second polarizing plate bonded to a back surface of the liquid crystal panel. The second polarizing plate includes a lower polarizing film controlling the amount of transmission light and polarizing a state of incident light and first supporting layers protecting and supporting front and back surfaces of the lower polarizing film.

In an exemplary embodiment, the first polarizing plate includes an upper polarizing film controlling the amount of transmission light and polarizing a state of light emitted from the liquid crystal panel, a second supporting layer protecting and supporting a back surface of the upper polarizing film and a third supporting layer protecting and supporting a front surface of the upper polarizing film.

In an exemplary embodiment, the second supporting layer is formed of an unstretched film including one of triacetyl cellulose (“TAC”), ZEONOR, ES-CINA and ARTON.

In an exemplary embodiment, the display device further includes touch signal pads connected to the first to fourth signal supply lines, liquid crystal signal pads formed on the lower substrate and a signal transmission film connecting the touch signal pads to the liquid crystal signal pads.

In an exemplary embodiment, a method of manufacturing a display device includes providing a liquid crystal panel including a lower substrate in which a thin film transistor, a color filter and a pixel electrode are formed and including an upper substrate in which a common electrode is formed, the lower and upper substrates facing each other with liquid crystals being disposed therebetween, forming a lower electrode of a touch panel on a front surface of the upper substrate of the liquid crystal panel, providing a polarizing plate polarizing incident light from the liquid crystal panel, forming an upper electrode of the touch panel on a back surface of the polarizing plate and bonding the polarizing plate to the liquid crystal panel so that the upper electrode faces the lower electrode.

In an exemplary embodiment, the method further includes forming first and second signal supply lines on edges of the upper electrode, forming a touch spacer on the upper electrode, forming an insulation adhesive covering the first and second signal supply lines and a peripheral region of the polarizing plate and forming third and fourth signal supply lines on edges of the lower electrode.

In an exemplary embodiment, the method further includes forming a first cell gap maintainer together with the first and second signal supply lines, and forming a second cell gap maintainer together with the third and fourth signal supply lines.

In an exemplary embodiment, the providing the polarizing plate includes forming an upper polarizing film controlling an amount of transmission light and polarizing a state of light emitted from the liquid crystal panel and forming a supporting layer protecting and supporting a front and back surface of the upper polarizing film, respectively.

In an exemplary embodiment, the supporting layer formed on the back surface of the upper polarizing film is formed of an unstretched film including one of triacetyl cellulose (“TAC”), ZEONOR, ES-CINA and ARTON.

In an exemplary embodiment, the method further includes forming touch signal pads connected to the first to fourth signal supply lines, respectively, forming liquid crystal signal pads on the lower substrate and connecting the touch signal pads to the liquid crystal signal pads with a signal transmission film.

### BRIEF DESCRIPTION OF THE DRAWINGS

The above and other objects, features and advantages of the present invention will become more apparent from the following detailed description when taken in conjunction with the accompanying drawings in which:

FIG. 1 is a cross-sectional view illustrating an exemplary embodiment of a display device having a touch panel according to the present invention;

FIG. 2 is a cross-sectional view illustrating the upper polarizing plate, illustrated in FIG. 1, on which the upper electrode in FIG. 1 is formed;

FIGS. 3A and 3B are plan views illustrating the touch panel illustrated in FIG. 1;

FIG. 4 is a cross-sectional view illustrating a flexible circuit film attached between the touch panel and the liquid crystal panel illustrated in FIG. 1;

FIGS. 5A to 5D are plane views sequentially illustrating an exemplary embodiment of a process of forming the upper electrode, first and second signal supply lines, touch spacers, and insulation adhesive of the touch panel illustrated in FIG. 3A;

FIGS. 6A and 6B are plane views sequentially illustrating an exemplary embodiment of a process of forming the lower electrode, and third and fourth signal supply lines of the touch panel illustrated in FIG. 3B; and

FIG. 7 is a plane view illustrating the touch panel formed between the upper polarizing plate and the liquid crystal panel illustrated in FIG. 1.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “under,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “under” or “lower” relative other elements or features would then be oriented “above” or “upper” relative to the other elements or features. Thus, the exemplary term “under” and “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The exemplary embodiments of the present invention will now be described with reference to the attached drawings.

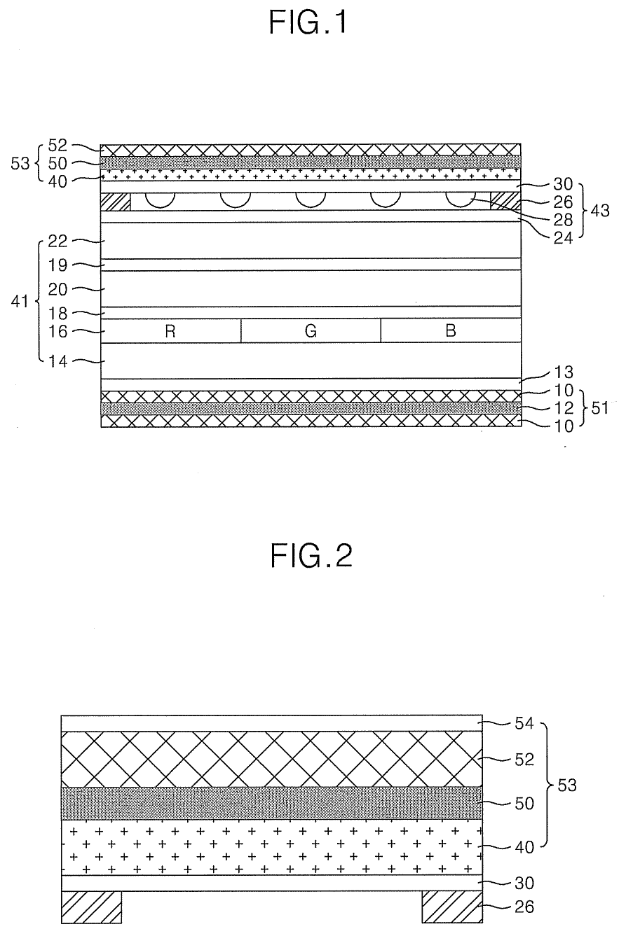

FIG. 1 is a cross-sectional view illustrating an exemplary embodiment of a display device having a touch panel according the present invention.

The display device illustrated in FIG. 1 includes a liquid crystal panel 41, a touch panel 43 mounted on the liquid crystal panel 41, and lower and upper polarizing plates 51 and 53 bonded, respectively, to a back (or lower) surface of the liquid crystal panel 41 and to a front (or upper) surface of the touch panel 43.

The liquid crystal panel 41 includes a thin film transistor (“TFT”) (not shown) connected to a gate line and to a data line, a color filter 16 for displaying colors, a pixel electrode 18 connected to the TFT and being overlapped by the color filter 16 and a common electrode 19 forming a vertical electric field with respect to the pixel electrode 18.

In exemplary embodiments, the common electrode 19 is formed of the same transparent conductive layer as the pixel electrode 18 on a back (or lower) surface of an upper substrate 22. A reference voltage for driving liquid crystals, that is, a common voltage is supplied to the common electrode 19.

In an alternative exemplary embodiment, a black matrix (not shown) for separating the color filter 16 formed on a lower substrate 14 according to red (R), green (G), and blue (B) pixels may also be formed on the back surface of the upper substrate 22.

The TFT is formed on the lower substrate 14 and selectively supplies a data signal from the data line to the pixel electrode 18 in response to a gate signal from the gate line. To this end, the TFT includes a gate electrode connected to the gate line, a source electrode connected to the data line, a drain electrode connected to the pixel electrode 18, an active layer overlapping the gate electrode with a gate insulating layer being disposed therebetween and forming a channel between the source electrode and the drain electrode, and an ohmic contact layer for providing ohmic contact between the active layer, and the source and drain electrodes.

The color filter 16 is formed on the lower substrate 14 to discriminate between colors on the basis of the black matrix. The color filter 16 is separately formed according to R, G and B to display R, G and B colors, respectively.

The pixel electrode 18 is formed to overlap and face the R, G and B color filters in each pixel area and connected to the drain electrode of the TFT. The pixel electrode 18 overlaps and faces the common electrode 19 with a liquid crystal layer 20 being disposed therebetween and forms a vertical electric field therebetween. If a video signal is supplied through the TFT, the pixel electrode 18 forms a vertical electric field with the common electrode 19 to which the common voltage is supplied and causes vertically arranged liquid crystal molecules to rotate by dielectric anisotropy. The transmittance of light transmitting a pixel area differs according to the rotating degree of the liquid crystal molecules, thereby achieving a gray level.

The lower polarizing plate 51 is bonded to the back surface of the liquid crystal panel 41 through a bonding member 13, such as an adhesive. The lower polarizing plate 51 includes a lower polarizing film 12 for controlling the amount of transmission light and polarizing state of incident light from a backlight unit and first supporting layers 10 for protecting and supporting the lower polarizing film 12.

In an exemplary embodiment, the lower polarizing film 12 may be formed by stretching a thin polyvinyl alcohol (“PVA”) film while heating it and by dipping iodic acid into dichroism pigment solution. The lower polarizing plate 51 including the lower polarizing film 12 has a stretching axis of a direction stretching the lower polarizing film 12 and a transmission axis perpendicular to the stretching axis.

In exemplary embodiments, the first supporting layers 10 are formed of triacetyl cellulose (“TAC”), etc. on the front and back surfaces of the lower polarizing film 12. The first supporting layers 10 reduce or effectively prevent shrinkage of the stretched polarizing film 12 protect and support the polarizing film 12.

As illustrated in FIG. 2, the upper polarizing plate 53 includes an upper polarizing film 50 for controlling the amount of transmission light and polarizing state of incident light from the liquid crystal panel 41, second and third supporting layers 40 and 52 for protecting and supporting the upper polarizing film 50 and a surface processor 54 formed on the third supporting layer 52.

In an exemplary embodiment, the upper polarizing film 50 and the third supporting layer 52 may be formed of the same material and perform the same role as the lower polarizing film 12 and the first supporting layers 10, respectively. Therefore, a detailed description thereof will be omitted.

The second supporting layer 40 supports the upper polarizing film 50 and serves as a base film necessary for forming an upper electrode 30 of the touch panel 43. The second supporting layer 40 may be formed of an unstretched film including any one of TAC, ZEONOR, ES-CINA, and ARTON. Since the second supporting layer 40 is formed under the upper polarizing film 50, there should be no optical anisotropy.

The surface processor 54 may be formed of an antireflecting layer for reducing or effectively preventing the reflection of incident light from the exterior and/or a hard coating layer for intensifying the surface hardness of the upper polarizing plate 53.

The touch panel 43 includes a lower electrode 24 formed on the front surface of the upper substrate 22 of the LC panel 41, the upper electrode 30 formed on the back surface of the upper polarizing plate 53, touch spacers 28 for maintaining a cell gap between the upper and lower electrodes 30 and 24, and an insulation member 26, also considered as an “insulation adhesive,” formed between the upper and lower electrodes 30 and 24. In an exemplary embodiment, the entire thickness of the touch panel 43 and the upper polarizing plate 53 is about 20 microns (μm) to about 200 microns (μm).

In exemplary embodiments, the upper electrode 30 may be formed of a transparent conductive material, such as indium tin oxide (“ITO”), on the back surface of the second supporting layer 40 of the upper polarizing plate 53 as illustrated in FIGS. 1 and 2. In one exemplary embodiment, the upper electrode 30 may be formed by increasing a partial pressure ratio of O₂ at a temperature lower than a glass transition temperature (Tg) of about 130° C. to about 170° C. when it is deposited on the second supporting layer 40, thereby increasing its resistance.

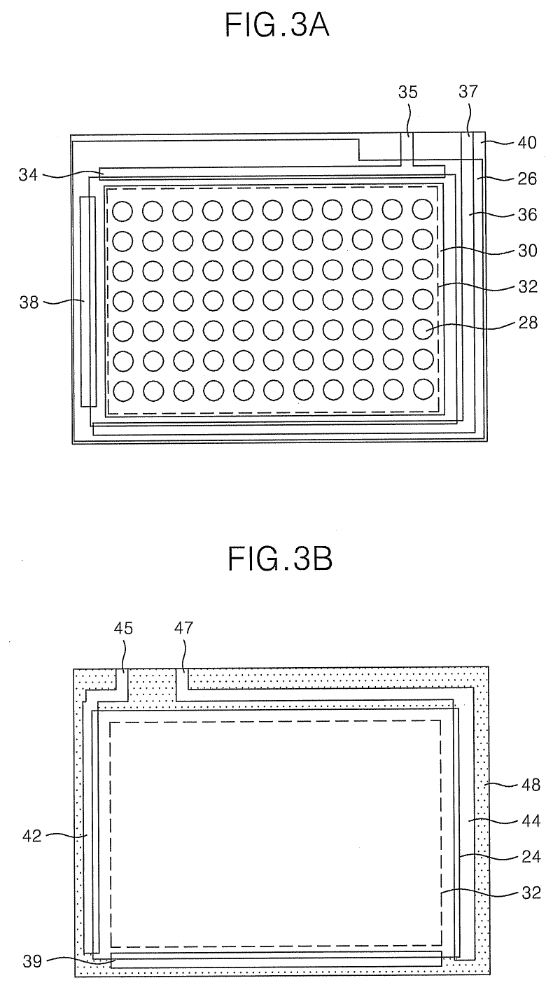

As illustrated in FIG. 3A, the upper electrode 30 is formed to have an area including an image display part 32 in which a plurality of liquid crystal cells of the liquid crystal panel 41 is formed.

First and second signal supply lines 34 and 36 facing each other and being substantially parallel to each other in the Y-axis direction (e.g., horizontal direction of FIG. 3A) are formed on edges of the upper electrode 30 (e.g. substantially around a periphery). The second signal supply line 36 is formed not only in the Y-axis direction but also in the X-axis direction (e.g., vertical direction of FIG. 3A) such that a first touch signal pad 35 of the first signal supply line 34 can be adjacent to a second touch signal pad 37 of the second signal supply line 36.

A cell gap maintenance pattern 38 for maintaining a cell gap is formed on an edge of the upper electrode 30 except where the first and second signal supply lines 34 and 36 are formed. The cell gap maintenance pattern 38 is formed to be substantially the same height (e.g., in a Z-axis direction) and the same material as the first and second signal supply lines 34 and 36.

The touch spacers 28 are formed such that the upper electrode 30 comes in contact with the lower electrode 24 by a pressure applied to the upper electrode 30. The touch spacers 28 protrude with a height (or length) smaller than an interval between the upper and lower electrodes 30 and 24. In exemplary embodiments, these touch spacers 28 may be formed by screen-printing or printing a ultraviolet (“UV”) hardening material and/or thermal hardening material on the back surface of the upper electrode 30.

The insulation adhesive 26 is formed to cover the first and second signal supply lines 34 and 36 and cover an outer region (e.g., proximate to the edges) of the second supporting layer 40 except in an area of the upper electrode 30. The insulation adhesive 26 is formed to expose the first and second touch signal pads 35 and 37. The insulation adhesive 26 reduces or effectively prevents a short between the first and second signal supply lines 34 and 36. The insulation adhesive 26 also reduces or effectively prevents a short between third and fourth signal supply lines 42 and 44 connected to the lower electrode 24 and ensures adhesive force between the upper and lower electrodes 30 and 24 when the upper and lower electrodes 30 and 24 are connected to each other.

In an exemplary embodiment, the lower electrode 24 may be formed by depositing a transparent conductive material, such as ITO, by use of a shadow mask or tapping mask having higher stability than a photolithography process and an etching process on the front surface of the upper substrate 22 on which a black matrix 48 is formed. Since the lower electrode 24 may be formed by increasing a partial pressure ratio of O₂ at a temperature lower than a glass transition temperature (Tg) when it is deposited on the front surface of the upper substrate 22, its resistance is increased. In addition, the lower electrode 24 is formed on the front surface of the cleaned or surface-processed upper substrate 22, its adhesive force with the upper substrate 22 is increased.

The third and fourth signal supply lines 42 and 44 face each other and are substantially parallel to each other in the X-axis direction are formed on the edges of the lower electrode 24. The fourth signal supply line 44 is formed not only in the X-axis direction (e.g., vertical direction of FIG. 3B) but also in the Y-axis direction (e.g., horizontal direction of FIG. 3B) such that a third touch signal pad 45 of the third signal supply line 42 is adjacent to a fourth touch signal pad 47 of the fourth signal supply line 44.

A cell gap maintenance pattern 39 for maintaining a cell gap is formed on an edge of the lower electrode 24 except where the third and fourth signal supply lines 42 and 44 are formed. The cell gap maintenance pattern 39 is formed to be the same height and the same material as the third and fourth signal supply lines 42 and 44.

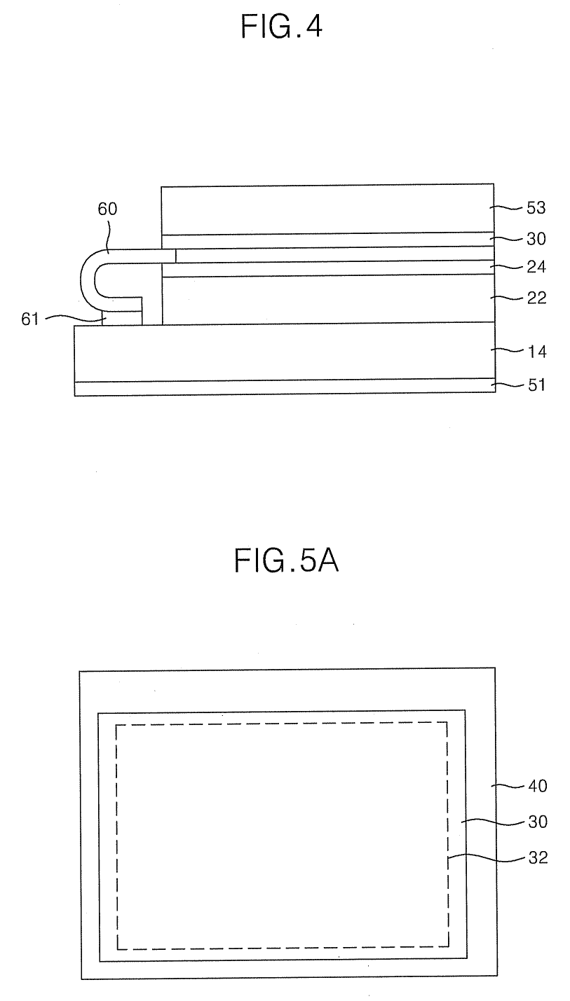

The first to fourth touch signal pads 35, 37, 45 and 47 are connected to a liquid crystal signal pad 61 formed on the lower substrate 14 through a flexible circuit film 60, as illustrated in FIG. 4. The liquid crystal signal pad 61 is connected to first signal terminals of the flexible circuit film 60 through an anisotropic conductive film (“ACF”) including conductive balls, and the touch signal pads 35, 37, 45 and 47 are connected to second signal terminals of the flexible circuit film 60 through an ACF including conductive balls. Then a driving signal input from the exterior is supplied to two of the first to fourth touch signal pads 35, 37, 45 and 47 through the liquid crystal signal pad 61, the first signal terminals and the second signal terminals. The driving signal is supplied to the upper and lower electrodes 30 and 24 through the touch signal pads 35, 37, 45 and 47 and the signal supply lines 34, 36, 42 and 44. X-axis and Y-axis coordinate signals generated while the upper and lower electrodes 30 and 24 contact with each other are supplied to a timing controller of the touch panel 43 through the signal supply lines, the other two touch signal pads among the first to fourth touch signal pads 35, 37, 45 and 47, the second signal terminals, the first signal terminals, and the liquid crystal signal pad 61.

In an exemplary embodiment, if the upper electrode 30 becomes in touch with the lower electrode 24 by pressing the upper polarizing plate 51 such as with a pen or finger at a location, the touch panel 43 varies a resistance value according to the touch location. Since a current or voltage becomes different according to the varied resistance, the touch panel 43 outputs the X-axis and Y-axis coordinate signals by the converted current or voltage through the first to fourth signal supply lines 34, 36, 42 and 44 and the first to fourth touch signal pads 35, 37, 45 and 47.

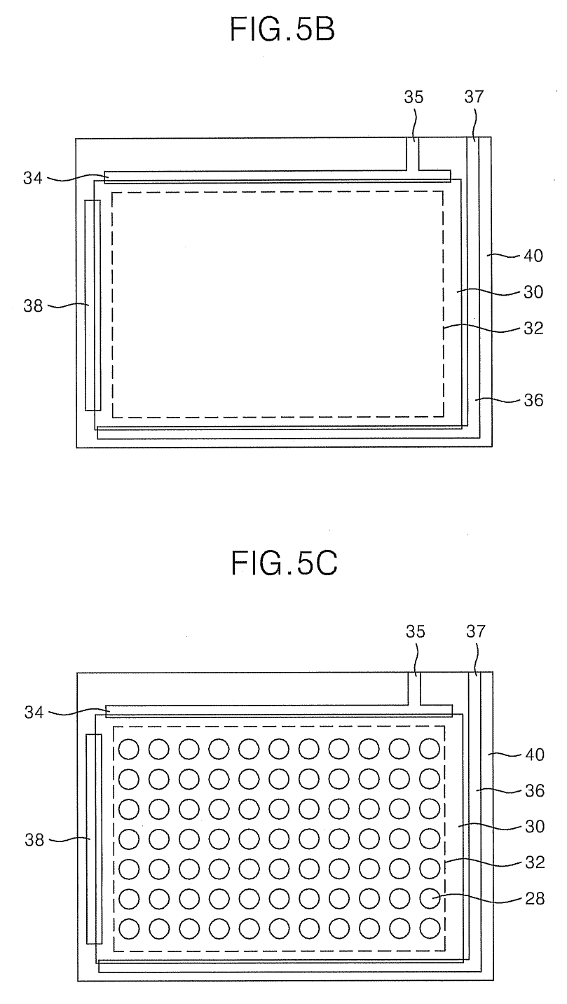

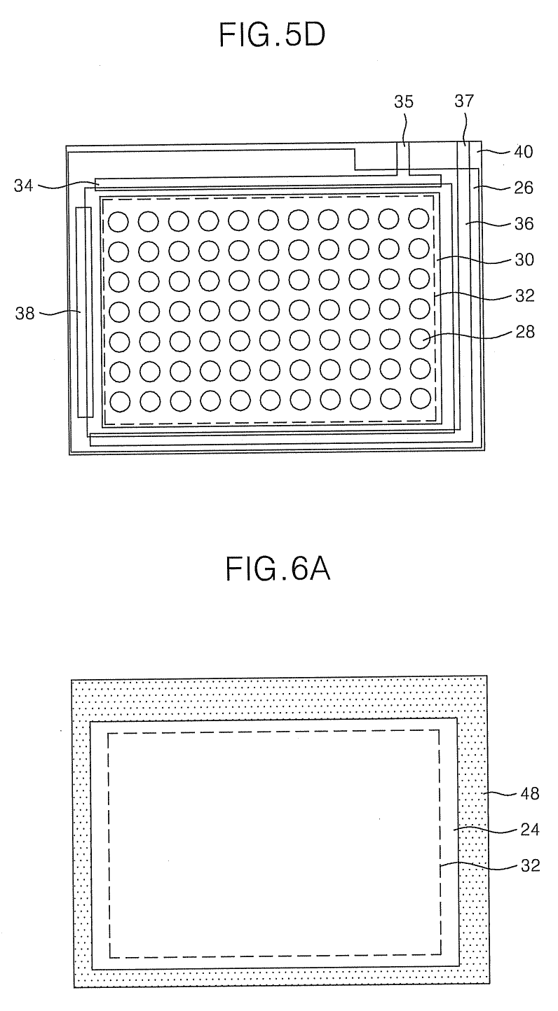

FIGS. 5A to 5D are plane views sequentially illustrating exemplary embodiments of a process of forming the upper electrode 30, first and second signal supply lines 34 and 36, touch spacers 28 and insulation adhesive 26 of the touch panel 43 illustrated in FIG. 3A.

Referring to FIG. 5A, the upper electrode 30 overlapping the image display part 32 of the liquid crystal panel is formed by depositing a transparent conductive material on the back surface of the second supporting layer 40 of the upper polarizing plate 53. Thereafter, a low-resistance metal is deposited on edges of the upper electrode 30. The low-resistance metal is patterned by a photolithography process and an etching process.

The first and second signal supply lines 34 and 36 and the first and second touch signal pads 35 and 37 connected respectively to the first and second signal supply lines 34 and 36 are formed, as illustrated in FIG. 5B. A cell gap maintenance pattern 38 for maintaining a cell gap is formed on an edge of the upper electrode 30 except where the first and second signal supply lines 34 and 36 are formed. The cell gap maintenance pattern 38 is formed to be substantially the same height (e.g., in a Z-axis direction) and the same material as the first and second signal supply lines 34 and 36.

A UV hardening resin or thermal hardening resin is deposited by a screen printing or printing method on the upper electrode 30 in which the first and second signal supply lines 34 and 36 are formed, thereby forming the touch spacers 28 as illustrated in FIG. 5C.

The insulation member (e.g., adhesive) 26 is formed as illustrated in FIG. 5D to cover the first and second signal supply lines 34 and 36 and the outer region of the second supporting layer 40. The insulation adhesive 26 is formed to expose the first and second touch signal pads 35 and 37.

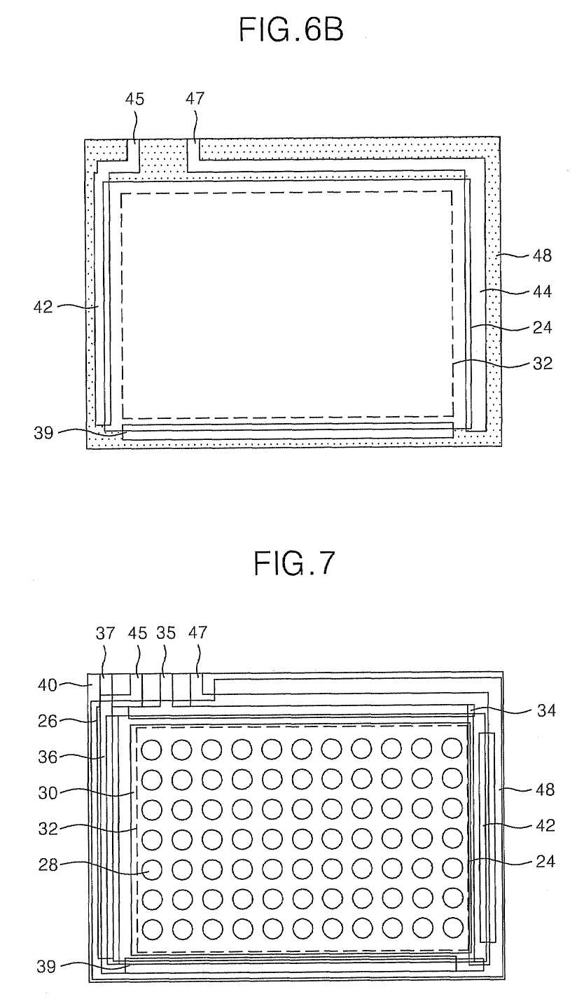

FIGS. 6A and 6B are plane views sequentially illustrating exemplary embodiments of a process of forming the lower electrode 24 and the third and fourth signal supply lines 45 and 47 of the touch panel 43 illustrated in FIG. 3B.

Referring to FIG. 6A, the lower electrode 24 overlapping the image display part 32 of the liquid crystal panel 41 is formed by depositing a transparent conductive material on the front surface of the upper substrate 22 of the liquid crystal panel 41 on which a black matrix 48 is formed. In this case, the liquid crystal panel 41 is in a state that liquid crystals are drop-filled or injected by a drop-filling process or an injection process.

A low resistance metal is deposited on edges of the lower electrode 24 and then the low resistance metal is patterned by a photolithography process and an etching process. As a result, the third and fourth signal supply lines 42 and 44, and the third and fourth touch signal pads 45 and 47 connected respectively to the third and fourth signal supply lines 42 and 44 are formed as illustrated in FIG. 6B. A cell gap maintenance pattern 39 for maintaining a cell gap is formed on an edge of the lower electrode 24 except where the third and fourth signal supply lines 42 and 44 are formed. The cell gap maintenance pattern 39 is formed to be the same height and the same material as the third and fourth signal supply lines 42 and 44.

Referring to FIG. 7, the touch panel 43 in which the upper electrode 30, the first and second signal supply lines 34 and 36, the touch spacers 28 and the insulation adhesive 26 are formed is bonded to the upper substrate 22 of the liquid crystal panel 41 on which the lower electrode 24, the third and fourth signal supply lines 45 and 47 are formed. Therefore, the touch panel 43 and the liquid crystal panel 41 are unitedly formed.

As in the illustrated exemplary embodiments of the display device, the upper electrode of the touch panel is formed on the upper polarizing plate and the lower electrode of the touch panel is formed on the upper substrate of the liquid crystal panel. Since upper and lower films on which conventional upper and lower electrodes are formed are not required, it is possible to make the display device thin and lightweight.

In an exemplary embodiment, the display device can reduce manufacturing cost and simplify a manufacturing process by not requiring the upper and lower films.

While the invention has been shown and described with reference to exemplary embodiments thereof, it will be understood by those skilled in the art that various changes in form and details may be made therein without departing from the spirit and scope of the invention as defined by the appended claims.

What is claimed is:

1. A display device, comprising:
a liquid crystal panel including an upper substrate and a lower substrate that face each other with liquid crystals being disposed therebetween;
a first polarizing plate bonded to a front surface of the liquid crystal panel; and
a touch panel including a lower electrode formed on the upper substrate of the liquid crystal panel and an upper electrode formed on a back surface of the first polarizing plate;
wherein the liquid crystal panel further includes a thin film transistor formed on the lower substrate, a pixel electrode connected to the thin film transistor, a color filter formed on the lower substrate and a common electrode formed on the upper substrate and forming an electric field with the pixel electrode.

2. The display device as set forth in claim 1, wherein the touch panel further includes:
first and second signal supply lines formed on edges of the upper electrode;
third and fourth signal supply lines formed on edges of the lower electrode;
an insulation adhesive formed between the first and second signal supply lines and the third and fourth signal supply lines; and
a touch spacer formed on the upper electrode.

3. The display device as set forth in claim 2, wherein the touch panel further includes:
a first cell gap maintainer formed of the same material on a same plane as the first and second signal supply lines; and
a second cell gap maintainer formed of the same material on a same plane as the third and fourth signal supply lines.

4. The display device as set forth in claim 1, further comprising a second polarizing plate bonded to a back surface of the liquid crystal panel, wherein the second polarizing plate includes a lower polarizing film controlling the amount of transmission light and polarizing a state of incident light, and first supporting layers protecting and supporting front and back surfaces of the lower polarizing film, respectively.

5. The display device as set forth in claim 4, wherein the first polarizing plate includes:
an upper polarizing film controlling an amount of transmission light and polarizing a state of light emitted from the liquid crystal panel;
a second supporting layer protecting and supporting a back surface of the upper polarizing film; and
a third supporting layer protecting and supporting a front surface of the upper polarizing film.

6. The display device as set forth in claim 5, wherein the second supporting layer is formed of an unstretched film including one of triacetyl cellulose (“TAC”), ZEONOR, ES-CINA and ARTON.

7. The display device as set forth in claim 2, further comprising:
touch signal pads connected to the first to fourth signal supply lines, respectively;
liquid crystal signal pads formed on the lower substrate; and
a signal transmission film connecting the touch signal pads to the liquid crystal signal pads, respectively.

8. A method of manufacturing a display device, the method comprising:
providing a liquid crystal panel including a lower substrate in which a thin film transistor, a color filter and a pixel electrode are formed and including an upper substrate in which a common electrode is formed, the lower and upper substrates facing each other with liquid crystals being disposed therebetween;
forming a lower electrode of a touch panel on a front surface of the upper substrate of the liquid crystal panel;
providing a polarizing plate polarizing incident light from the liquid crystal panel;
forming an upper electrode of the touch panel on a back surface of the polarizing plate; and
bonding the polarizing plate to the liquid crystal panel so that the upper electrode faces the lower electrode.

9. The method as set forth in claim 8, further comprising:
forming first and second signal supply lines on edges of the upper electrode;
forming a touch spacer on the upper electrode;
forming an insulation adhesive covering the first and second signal supply lines and a peripheral region of the polarizing plate; and
forming third and fourth signal supply lines on edges of the lower electrode.

10. The method as set forth in claim 9, wherein the first supply line is formed on a first edge and the second supply line is formed on a second edge and a third edge of the upper electrode, the first edge being adjacent to the second edge and the second edge being adjacent to the third edge;
wherein the third supply line is formed on a second edge and the fourth supply line is formed on a first edge and a fourth edge of the lower electrode, the second edge being adjacent to the first edge and the fourth edge being adjacent to the first edge; wherein the first edge and the second edge of the upper electrode corresponds to the first edge and the second edge of the lower electrode.

11. The method as set forth in claim 10, further comprising:
forming a first cell gap maintainer together with the first and second signal supply lines; and
forming a second cell gap maintainer together with the third and fourth signal supply lines.

12. The method as set forth in claim 8, wherein the providing a polarizing plate includes:
forming an upper polarizing film controlling an amount of transmission light and polarizing a state of light emitted from the liquid crystal panel; and
forming a supporting layer protecting and supporting a front and back surface of the upper polarizing film, respectively.

13. The method as set forth in claim 12, wherein the supporting layer formed on the back surface of the upper polarizing film is formed of an unstretched film including one of triacetyl cellulose (“TAC”), ZEONOR, ES-CINA and ARTON.

14. The method as set forth in claim 9, further comprising:
forming touch signal pads connected to the first to fourth signal supply lines, respectively;
forming liquid crystal signal pads on the lower substrate; and
connecting the touch signal pads to the liquid crystal signal pads with a signal transmission film.
